(19) United States
(12) Patent Application Publication
(10) Pub. No.: US 2013/0058444 A1
(43) Pub. Date: Mar. 7, 2013

(54) Fault Tolerant Communications Over a Two-Wire Interface

(71) Applicants: Norman Tang, Los Altos, CA (US); David Lai, Mountain View, CA (US); Liang Ping Peng, Santa Clara, CA (US); Anthony Nguyen, San Jose, CA (US)

(72) Inventors: Norman Tang, Los Altos, CA (US); David Lai, Mountain View, CA (US); Liang Ping Peng, Santa Clara, CA (US); Anthony Nguyen, San Jose, CA (US)

(73) Assignee: Cisco Technology, Inc., San Jose, CA (US)

(21) Appl. No.: 13/225,670

(22) Filed: Sep. 6, 2011

(51) Int. Cl. H04L 7/00

(52) U.S. Cl. 375/354

(57) ABSTRACT

Techniques are provided for fault-tolerant communications over a two-wire interface. A method for such communications includes iteratively initiating transfer of data between a master device and a slave device via a two-wire interface, and, prior to each iteration, transmitting a flushing bit-stream from the master device to the slave device. The flushing bit-stream is configured to align the operations of the slave device with the operations of the master device.

### TECHNICAL FIELD

The present disclosure relates to a two-wire interface.

### BACKGROUND

Host devices (switches, routers, etc.) may be configured to connect to pluggable modules that facilitate data communications within a network. Pluggable modules generally are transceivers that interface the host device with a fiber optic or copper networking cable. As such, pluggable modules are generally configured to convert electrical signals received from the host device into transmit signals for transmission via the network cable, and to convert receive signals received via the network cable into electrical signals usable by the host device.

Pluggable modules generally receive control signals from the host device via a two-wire interface (also known as the I²C bus). The two-wire interface physically includes two bi-directional active connections (open-drain wires pulled up with resisters). Modules typical use a voltage of 3.3 volts. The active connections are known as the serial data (SDA) line, which carries the data bits, and the serial clock line (SCL), which is used as a clock signal.

### BRIEF DESCRIPTION OF THE DRAWINGS

FIG. 1 is a block diagram of a host device connected to a pluggable module, where the host device and pluggable module are configured to communicate over a two-wire interface using a communication protocol that includes a flushing bit-stream prior to the initiation of data transfer.

FIG. 2 is a schematic diagram of communications over the two-wire interface in accordance with the communication protocol that includes the flushing bit-stream prior to the initiation of data transfer.

FIG. 3 is a diagram illustrating the signals on a clock signal line and a data signal line of the two-wire interface during transmission of the flushing bit-stream.

FIG. 4 is a diagram schematically illustrating the use of a conventional protocol and the communication protocol that includes the transmission of the flushing bit-stream prior to the initiation of data transfer.

FIG. 5 is a flowchart of a method for communicating over the two-wire interface in accordance with the communication protocol that includes the transmission of the flushing bit-stream prior to the initiation of data transfer.

FIG. 6 is a flowchart of a method for transmitting the flushing bit-stream from a master device to a slave device.

### DESCRIPTION OF EXAMPLE EMBODIMENTS

### Overview

Techniques are provided for fault-tolerant communications over a two-wire interface. A method for such communications includes iteratively initiating transfer of data between a master device and a slave device via a two-wire interface, and, prior to each iteration, transmitting a flushing bit-stream from the master device to the slave device. The flushing bit-stream is configured to align the operations of the slave device with the operations of the master device.

### Example Embodiments

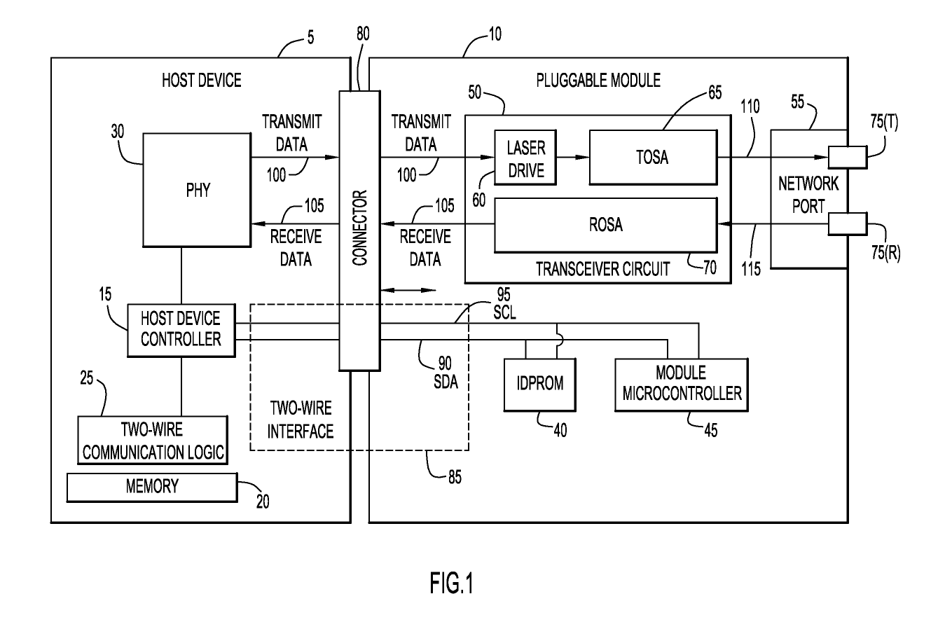

FIG. 1 is a block diagram of a host device 5 connected to a pluggable module 10. Host device 5 comprises a host device controller 15, two-wire communication logic 25, a physical (PHY) layer component 30, and memory 20. Pluggable module 10 includes non-volatile memory 40 which, in the example of FIG. 1, comprises Identification Programmable Read Only Memory (IDPROM), a module microcontroller 45, a transceiver circuit 50 and a network port 55. Transceiver circuit 50 includes a laser driver 60, a transmitter optical subassembly (TOSA) 65, and a receiver optical subassembly (ROSA) 70. Network port 55 includes optical connectors 75(T) and 75(R). The host device 5 may be, for example, a network switch or a router, and pluggable module 10 is a link for the host device 5 to a fiber optic or other cable (not shown in FIG. 1).

Host device 5 is coupled to pluggable module 10 via a connector 80. In the example of FIG. 1, connector 80 is formed by a plurality of electrical pins in host device 5 that are connected to a plurality of electrical pins in pluggable module 10. As such, in practice, connector 80 is formed by two mating connector parts, one in each of host device 5 and pluggable module 10. Accordingly, each of host device 5 and pluggable module 10 includes a connector part, but for simplicity they are collectively shown as connector 80.

Connector 80 includes a two-wire interface 85 between host device 5 and pluggable module 10. The two-wire interface 85 (also known as the I²C bus) physically includes two bi-directional active connections (wires). The active connections are known as serial data line (SDA) 90, which carries data bits between the host device 5 and pluggable module 10, and serial clock line (SCL) 95, which carries clock signals.

In the example of FIG. 1, the two-wire interface 85 is controlled by controller 15 through two-wire communication logic 25. However, it should be appreciated that one or more other elements may also be included to operate with, or replace controller 15, for control of two-wire interface 85. For example, in one alternative form, host device 15 may include a separate interface controller in the form of a Field Programmable Gate Array (FPGA), Application Specific Integrated Circuit (ASIC), etc., that controls operation of the two-wire interface 85.

Controller 15 is connected to two-wire communication logic 25 which, in the example of FIG. 1, is implemented as hardware elements. In certain circumstances, two-wire communication logic 25 may be implemented as digital logic gates in one or more application-specific integrated circuits (ASICS). Alternatively, two-wire communication logic 25 may be implemented as one or more software modules executable from memory 20 In such examples, memory 20 may comprise read only memory (ROM), random access memory (RAM), magnetic disk storage media devices, optical storage media devices, flash memory devices, electrical, optical, or other physical/tangible memory storage devices. The controller 15 is, for example, a microprocessor or microcontroller that executes instructions stored in memory 20. Thus, in general, the memory 20 may comprise one or more computer readable storage media (e.g., a memory device) encoded with software comprising computer executable instructions and when the software is executed (by the controller 15), it is operable to perform the operations described herein in connection with two-wire communication logic 25. The details of the operations associated with two-wire communication logic 25 are provided below.

Controller 15 is further connected to PHY 30. PHY 30 comprises the basic hardware transmission capabilities of host device 5 to modulate electrical signals to produce transmit data 100 that is supplied by connector 80 to transceiver circuit 50 in pluggable module 10. PHY 30 also receives electrical signals, referred to as receive data 105, from transceiver circuit 50, and demodulates the signals for recovering the data contained therein for use by the host device 5.

Transceiver circuit 50 in pluggable module 10 is configured to generate transmit signals 110 for transmission via network port 55. More specifically, laser driver 60 in transceiver circuit 50 receives transmit data 100 and generates drive signals for an LED or an injection laser diode in TOSA 65 that generates the optical transmit signals 110. Transmit signals 110 are provided to an optical fiber cable via optical connector 75(T) in network port 55. Similarly, transceiver circuit 50 is configured to process receive signals 115 received via the network port. That is, optical receive signals 115 are received by ROSA 70 via optical connector 75(R), and converted to electrical receive data 105.

FIG. 1 is an example in which pluggable module 10 converts electrical signals to optical signals for transmission via an optic fiber cable. It should be appreciated that in a different form, pluggable module may be configured to convert one form of electrical signals to another form (i.e., conversion from one electrical bandwidth to another electrical bandwidth) for transmission via a network cable. As such, in other forms, transceiver circuit 50 and network port 55 may be used with, for example, copper cable media.

Microcontroller 45 of pluggable module 10 controls operations of the pluggable module 10 and components thereof, such as transceiver circuit 50 and network port 55. Microcontroller 45 and IDPROM 40 communicate with controller 15 in host device 5 via two-wire interface 85. More particularly, microcontroller 45 receives data from, and/or provides data to, the controller 15, while the controller 15 reads data from IDPROM 40. IDPROM 40 may include data describing, for example, the pluggable module's capabilities, standard interfaces, manufacturer, and other information. In one example, IDPROM 40 is a 256-byte memory map in Electrically Erasable Programmable Read-Only Memory (EEPROM) of which the entire contents may be read by controller 15, or which may be read in shorter access segments.

As noted above, the two-wire interface 85 of FIG. 1 is a bus that includes SDA 90 (the data line) and SCL 95 (the clock line) connecting controller 15 with IDPROM 40 and microcontroller 45. In the example of FIG. 1, communication between controller 15 and IDPROM 40 or microcontroller 45 occurs in accordance with a communication protocol that includes a flushing-bit stream or sequence configured to synchronize operations of IDPROM 40 or microcontroller 45 with the operations of controller 15. As noted above, the communication protocol that includes the flushing bit-stream is facilitated through two-wire communication logic 25.

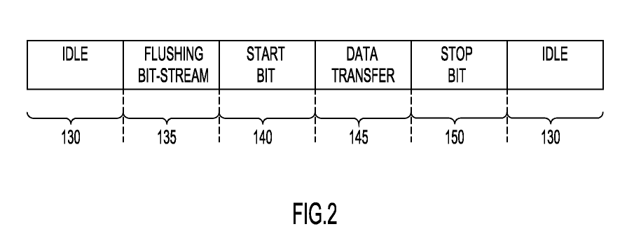

FIG. 2 is a schematic diagram illustrating example communications over two-wire interface 85 facilitated by two-wire communication logic 25. Devices connected via two-wire interface 85 may be either a master device or a slave device. The master device is the device that generates the clock signal for transmission via SCL 95, and which addresses the slave devices via SDA 90. In the example of FIG. 1, controller 15 is the master device and IDPROM 40 and microcontroller 45 are the slave devices.

The master device (controller 15) can either transmit data to one or more of the slave devices (e.g., microcontroller 45), or receive data from the slave devices (e.g., IDPROM 40 or microcontroller 45). The transmission or receipt of data by a master device is generally referred to herein as data transfer.

Example communications will be described below with reference to communication between controller 15 and IDPROM 40. During such communication, controller 15 and IDPROM 40 may each be in an idle state 130; controller 15 may be transmitting a flushing bit-stream 135, a start bit 140 or a stop bit 150; or controller 15 and IDPROM 40 may be performing data transfer 145.

When controller 15 and IDPROM 40 are in the idle state 130, no communication occurs between the devices. Controller 15 is configured to initiate data transfer 145 by transmitting a start bit 140 to IDPROM 40. After transmission of start bit 140, the data transfer occurs and is subsequently terminated by transmission of a stop bit 150. After transmission of the stop bit 150, the controller 15 and IDPROM 40 each return to the idle state 130.

As noted above, two-wire interface 85 is a serial interface. As such, for proper data transfer, the logic of the master device and the logic of the slave device should be aligned with respect to the communication protocol. When the slave device logic is aligned with the master device logic, the devices are each configured to perform corresponding (aligned) operations to implement the communication protocol. Corresponding or aligned operations include, for example, the master device is configured to transmit a start bit while the slave device is configured to receive the start bit, the master device is configured to transmit a stop bit while the slave device is configured to receive the stop bit, or both devices are configured for the transfer of the same data bit within the same data byte. Therefore, as used herein, alignment of the master device logic with the slave device logic means that the data transfer operations of the slave device are aligned with the data transfer operations of the master device.

Controller 15 and IDPROM 40 may have different timing and the logic may become offset from one another. Additionally, disruptions in host device 5 (resets, power cycles, etc.) may cause misalignment of the logic. Because slave devices only recognize certain bit-streams while in certain states, the effectiveness of communication over two-wire interface 85 depends on the slave being in the proper state at the time a bit or bit-stream is received. If the slave is in a different state than what is expected by the master device, the data transfer will not occur properly (e.g., a master device could believe it is transferring a first bit in a byte, while the slave device believes it is transferring a second bit in that byte).

In order to ensure proper alignment of the logic of a master device with a slave device, two-wire interface communications described herein include, as shown in FIG. 2, the transmission of flushing bit-stream 135 from the master device to the slave device. More specifically, prior to the initiation of each data transfer, flushing bit-stream 135 is transmitted from the master device (controller 15) to the slave device (IDPROM 40 or microcontroller 45) with which the data transfer is to occur. The flushing bit-stream 135 is a predetermined sequence of transmitted bits that are configured to align the logic of the slave device with the logic of the master device, thereby proactively preventing miscommunication that could occur as a result of logic misalignment. As described further below, this makes two-wire interface 85 tolerant to faults that occur, for example, in host device 5.

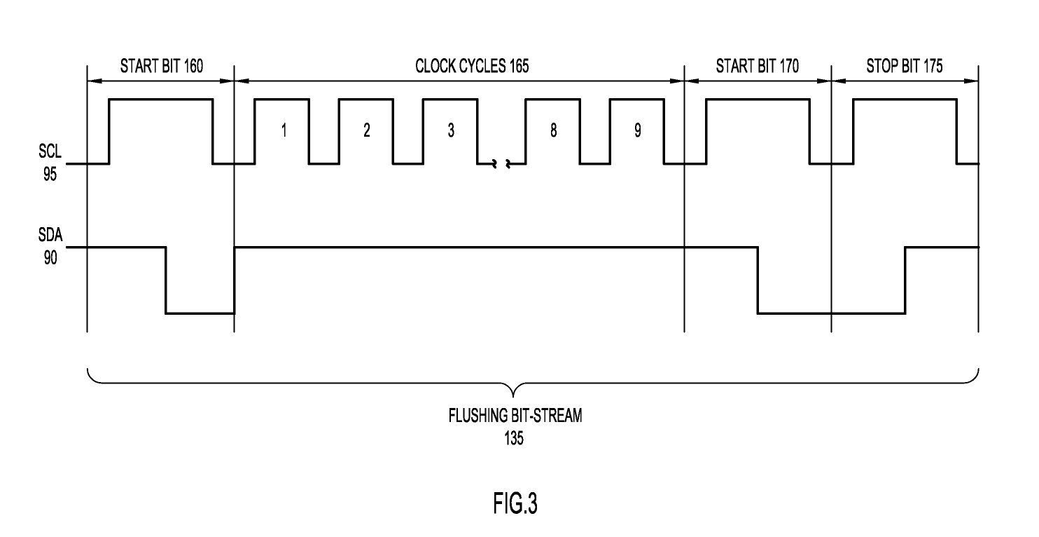

FIG. 3 is a schematic diagram illustrating the signals on SDA 90 and SCL 95 during transmission of the flushing bit-stream 135. At the physical layer, both SDA 90 and SCL 95 are of open-drain design. As such, pulling the lines to ground (i.e., low) is considered a logic zero (“0”) while allowing the lines to float (i.e., high) is a logic one (“1”). When communication is idle, both lines 90 and 95 are high.

The flushing bit-stream 135 beings with the transmission of a start bit 160 from controller 15 to a slave device such as, for example, IDPROM 40. To transmit the start bit 160, SDA 90 is pulled low while SCL 95 remains high. This initial start bit 160 is followed by a predetermined number or set of clock cycles 165. During transmission of these clock cycles, SDA 90 is allowed to float high as a logic 1 (i.e., SDA 90 remains connected to the power supply). In the example of FIG. 3, the set of clock cycles 165 comprises nine (9) clock cycles. The set of clock cycles 165 is followed by a second start bit 170. Similar to the first start bit 160, to transmit the start bit 170, SDA 90 is pulled low while SCL 95 remains high. Following transmission of the second start bit 170, a stop bit 175 is transmitted. To transmit stop bit 175, SDA 90 is pulled high as a logic 1 while SCL 95 remains high. After transmission of this sequence, the controller 15 is assured that the operations of IDPROM 40 are synchronized therewith, and that the IDPROM 40 is ready to receive a start bit that initiates data transfer.

In the example of FIG. 3, flushing bit-stream 135 is 12 bits long. When used, for example, before the reading of data from IDPROM 40, this 12 bit stream may negligibly increase the IDPROM access time by approximately 823 micro-seconds.

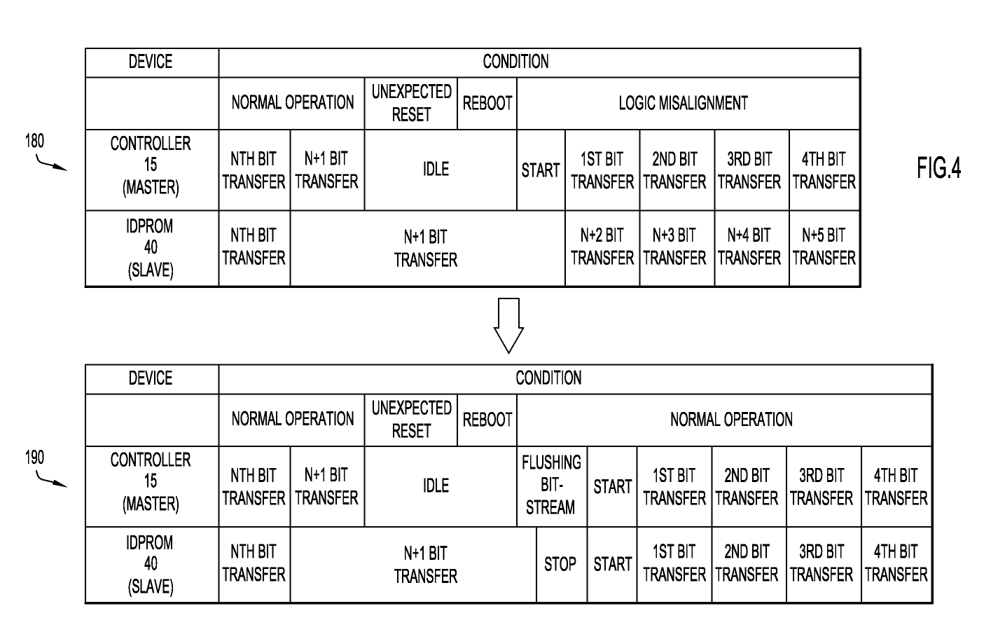

FIG. 4 is a diagram schematically illustrating conventional two-interface communications that may suffer from logic misalignment problems, as well as fault tolerant two-wire interface communications described herein that include a flushing bit-stream prior to the initiation of data transfer. More specifically, FIG. 4 includes a top section 180 illustrating the conditions of controller 15 and IDPROM 40 during conventional communication, and a bottom section 190 illustrating the conditions of controller 15 and IDPROM 40 during communication that includes a flushing bit-stream prior to the initiation of data transfer.

As shown in section 180, during initial, normal operation, the logic of controller 15 and IDPROM 40 are both aligned. When the logic is aligned, controller 15 and IDPROM 40 are each performing corresponding operations which, in the example of FIG. 4, include an N^{th} bit transfer by each of controller 15 and IDPROM 40 (i.e., each of controller 15 and IDPROM 40 are performing operations that facilitate the transfer of the Nth bit), followed by the N+1 bit transfer. During the N+1 bit transfer, controller 15 suffers an unexpected reset that terminates the data transfer and causes the controller 15 to enter an idle state where it remains while controller 15 reboots. However, the unexpected reset of controller 15 does not affect operation of IDPROM 40, and IDPROM 40 continues to operate as before in accordance with presumed normal operation. In other words, IDPROM 40 continues to operate (during the reset and reboot of controller 15) as if a delay has occurred during the N+1 bit transfer.

After reboot of controller 15, the controller transmits a start bit in an attempt to re-start the data transfer that was cut off by the unexpected reset (i.e., controller 15 jumps back to the beginning of the interrupted data transfer). However, as noted above, a slave device such as IDPROM 40 should be in a specific state in order to respond to certain bits or bit-sequences. Here, IDPROM 40 is in the middle of the data transfer (i.e., delayed at N+1) and cannot interpret the start bit from controller 15 as the re-start of the data transfer. Rather, when controller 15 tries to retrieve the 1^{st} bit in the new data transfer, IDPROM 40 interprets this as a request for the N+2 bit from the initial (delayed) transfer. Similarly, subsequent data transfer bits (i.e., the 2^{nd}, 3^{rd}, 4^{th}, etc. bits) are also interpreted by IDPROM 40 as subsequent requests for bits in the initial transfer (i.e., N+3, N+4, N+5, etc. bits). Because the unexpected reset of controller 15 results in the misalignment of the logic of controller 15 and IDPROM 40 (i.e., the two devices are not performing corresponding data transfer operations), the integrity of the data transfer is compromised. This may result in the reading of incorrect data from IDPROM 40 and/or reports of bus failure. Such operations may cause the software to jump into extra steps to manually re-align the logic of the controller 15 and the IDPROM 40, or to power cycle the pluggable module in order to re-align the logic. Such resets or manual alignment occur at a high software level, thus adding to the complexity of the software development and leading to delays in the data recovery process. As such, the communications shown in section 180 lack fault tolerant features that could proactively protect against host (master) misbehavior or disruptions in normal communications such as, for example, when the host is reset.

As noted above and as shown in section 190 of FIG. 4, techniques described herein proactively eliminate the occurrence of misalignment between master and slave devices. More particularly, as shown in section 190, during initial, normal operation, the logic of controller 15 and IDPROM 40 are both aligned. That is, controller 15 and IDPROM 40 are each performing corresponding operations which, in the example of FIG. 4, include an N^{th} bit transfer by each of controller 15 and IDPROM 40, followed by the N+1 bit transfer. During the N+1 bit transfer, controller 15 suffers an unexpected reset that terminates the data transfer and causes controller 15 to enter an idle state where it remains while controller 15 reboots. However, as noted above, this unexpected reset of controller 15 does not affect operation of IDPROM 40, and IDPROM 40 continues to operate as if a delay has occurred during the N+1 bit transfer.

After reboot of controller 15, the controller wishes to restart the terminated data transfer by transmitting a start bit to IDPROM 40. However, controller 15 does not know the logic state of IDPROM 40 and does not know if the IDPROM is ready to receive the start bit. Therefore, in order to proactively ensure that the logic of IDPROM 40 will be aligned with the logic of controller 15, controller 15 transmits a flushing bit-stream prior to the initiation of any data transfer. The flushing bit-stream is designed to make IDPROM 40 recognize that the initial data transfer is terminated, and places IDPROM 40 in the proper state to receive the start bit from controller 15. Therefore, when controller 15 sends the start bit, the IDPROM 40 will be ready to receive the 1^{st} bit, and subsequent bits, in the new data transfer. As such, the integrity of the data transfer is ensured by proactively preventing misalignment of the logic of controller 15 and IDPROM 40.

After an unexpected reset or other interruption in communications between controller 15 and IDPROM 40, the logic of the devices may be offset or misaligned, as shown above in section 190 of FIG. 40. However, certain interruptions may not result in a loss of alignment between controller 15 and IDPROM 40. As noted above, the flushing bit-stream is transmitted prior to each data transfer, regardless of whether the operations of the master and slave devices are aligned or whether a reset or reboot occurred. This provides a tradeoff between introducing a small amount of overhead (i.e., the flushing bit-stream) to each data transfer in order to ensure alignment of devices for every data transfer, and the potentially for comprised data transfer. This makes the two-wire interface overall more efficient.

The flushing-bit stream is configured such that it will not have an adverse impact if the logic of controller 15 and IDPROM 40 is aligned at the time the flushing bit-stream is transmitted.

The addition of the flushing bit-stream to the start of each data transfer provides fault tolerant protection at the lowest layer(s) of the two-wire interface, and substantially eliminates the need for the upper level software to recover the interface. The use of the flushing bit-stream has several advantages, one of which is the elimination of the disruption of the user traffic that results from conventional two-wire interface recovery. That is, in conventional devices, to recover the two-wire interface data transfer problems (i.e., lock up) are detected, and in response, the system software will issue a module-level reset that interrupts the data traffic through the pluggable module. In contrast, the flushing bit-stream prevents such disruptions by proactively eliminating potential data transfer problems. Another advantage is that the system performance is enhanced and the code is simplified because recovering faults at the higher software level typically takes more time and uses more software resources. In addition, at the higher level, the identification of root causes or faults is much more difficult.

Also, in certain circumstances, a host device, such as host device 5, may comprise multiple sub-host devices connected to pluggable module 10. In such circumstances, one of the sub-host devices may be active and the other one may be redundant. If the active sub-host device resets itself during the two-wire operation, and the redundant sub-host device takes over the control of the interface (i.e., becomes active), the redundant host may not want to keep the traffic running on the pluggable module 10 at the same point as it was terminated by the active sub-host. Additionally, the new controlling sub-host device may also not want to execute the module reset of pluggable module 10 (assuming the IDPROM 40 may be included into the module reset function). By sending the flushing-bit-stream along with the two-wire communication, the transceiver circuit 50 and network port 55 may continuous running without interruption.

Two-wire communications described herein that use the flushing bit-stream prior to the initiation of data transfer augment the standard two-wire communication protocol and are compatible with conventional slave devices. The communications are low overhead, transparent to upper level software and allow for fast synchronization of the logic of the master and slave devices.

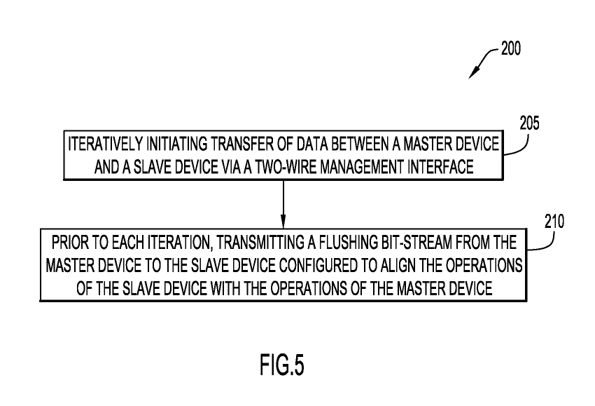

FIG. 5 is a flowchart of a method 200 for communicating over a two-wire interface in accordance with techniques described herein. Method 200 begins at 205 with the iterative initiation of the transfer of data between a master device and a slave device via a two-wire interface. At 210, prior to each iteration, a flushing bit-stream is transmitted from the master device to the slave device. As detailed above, the flushing bit-stream is configured to align the operations of the slave device with the operations of the master device. This alignment of operations proactively ensures the integrity of the subsequent data transfer (i.e., the data transfer during the respective iteration). Again, the flushing bit stream is sent in every case regardless of whether a misalignment exists.

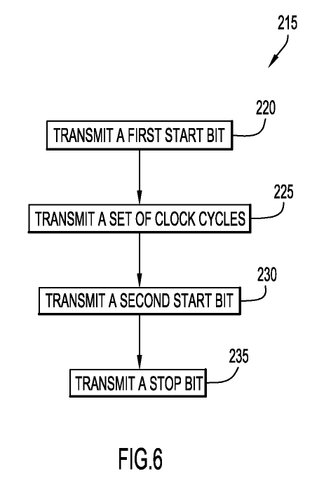

FIG. 6 is a flowchart of a method 215 for transmitting a flushing bit-stream. Method 215 begins at 220 with the transmission of a first start bit from the master device to the slave device. At 225, a set of clock cycles is transmitted from the master device to the slave device, followed by the transmission of a second start bit from the master device to the slave device at 230. The flushing bit-stream ends at 235 with the transmission of a stop bit from the master device to the slave device.

Techniques are described herein with reference to communication protocols used during communication over a two-wire interface between a host device and a pluggable module. The disclosed techniques may be implemented in conjunction with different types of pluggable modules such as, and not limited to, Small Form-Factor Pluggable (SFP), SFP+, Quad SFP (QSFP), 10 Gigabit SFP (XFP), C Form-Factor Pluggable (CFP) modules, etc. Additionally, it is to be appreciated that the techniques described herein are not limited to host device/pluggable module communications, but rather may implemented in conjunction with any two-wire interface.

The above description is intended by way of example only.

What is claimed is:

1. A method comprising:
iteratively initiating transfer of data between a master device and a slave device via a two-wire interface; and
prior to each iteration, transmitting a flushing bit-stream from the master device to the slave device configured to align the operations of the slave device with the operations of the master device.

2. The method of claim 1, wherein the two-wire interface comprises a clock signal line and a data signal line and wherein transmitting a flushing bit-stream comprises:
transmitting a first start bit;
transmitting a set of clock cycles;
transmitting a second start bit; and
transmitting a stop bit.

3. The method of claim 2, wherein transmitting the first start bit comprises:
transmitting one clock cycle on the clock signal line; and
transitioning the data signal line from a high state to a low state during the transmission of the clock cycle.

4. The method of claim 2, wherein transmitting the second start bit comprises:
transmitting one clock cycle on the clock signal line; and
transitioning the data signal line from a high state to a low state during the transmission of the clock cycle.

5. The method of claim 2, wherein transmitting the stop bit comprises:
transmitting one clock cycle on the clock signal line; and
transitioning the data signal line from a low state to a high state during the transmission of the clock cycle.

6. The method of claim 2, wherein transmitting the set of clock cycles comprises:
transmitting set of nine clock cycles on the clock signal line; and
holding the data signal line high during the transmission of the nine clock cycles.

7. The method of claim 1, wherein following at least one initiation of data transfer the method further comprises:
receiving data from the slave device over the two-wire interface.

8. The method of claim 1, wherein following at least one initiation of data transfer the method further comprises:
transmitting data to the slave device over the two-wire interface.

9. An apparatus comprising:
a controller; and
a two-wire interface connecting the controller to a slave device,
wherein the controller is configured to iteratively initiate transfer of data with the slave device via the two-wire management interface, and prior to each iteration, transmit a flushing bit-stream to the slave device configured to align the operations of the slave device with the operations of the controller.

10. The apparatus of claim 9, wherein the two-wire interface comprises a clock signal line and a data signal line and, wherein to transmit the flushing bit-stream the controller is configured to transmit a first start bit, transmit a set of clock cycles, transmit a second start, and transmit a stop bit.

11. The apparatus of claim 10, wherein to transmit the first start bit the controller is configured to transmit one clock cycle on the clock signal line, and to transition the data signal line from a high state to a low state during the transmission of the clock cycle.

12. The apparatus of claim 10, wherein to transmit the second start bit the controller is configured to transmit one clock cycle on the clock signal line, and to transition the data signal line from a high state to a low state during the transmission of the clock cycle.

13. The apparatus of claim 10, wherein to transmit the stop bit the controller is configured to transmit one clock cycle on the clock signal line, and to transition the data signal line from a low state to a high state during the transmission of the clock cycle.

14. The apparatus of claim 10, wherein to transmit the set of clock cycles the controller is configured to transmit nine clock cycles on the clock signal line, and to hold the data signal line high during the transmission of the nine clock cycles.

15. The apparatus of claim 9, wherein following at least one initiation of data transfer the controller is configured to receive data from the slave device over the two-wire interface.

16. The apparatus of claim 9, wherein following at least one initiation of data transfer the controller is configured to transmit data to the slave device over the two-wire interface.

17. The apparatus of claim 9, wherein the slave device is non-volatile memory in a pluggable module.

18. One or more computer readable storage media encoded with software comprising computer executable instructions and when the software is executed operable to:
iteratively initiate transfer of data between a master device and a slave device via a two-wire management interface; and
prior to each iteration, transmit a flushing bit-stream from the master device to the slave device configured to align the operations of the slave device with the operations of the master device.

19. The computer readable storage media of claim 18, wherein the two-wire interface comprises a clock signal line and a data signal line and wherein the instructions operable to transmit the flushing bit-stream comprise instructions operable to:
transmit a first start bit;
transmit a set of clock cycles;
transmit a second start bit; and
transmit a stop bit.

20. The computer readable storage media of claim 19, wherein instructions operable to transmit the first start bit comprise instructions operable to:
transmit one clock cycle on the clock signal line; and
transition the data signal line from a high state to a low state during the transmission of the clock cycle.

21. The computer readable storage media of claim 19, wherein instructions operable to transmit the second start bit comprise instructions operable to:
transmit one clock cycle on the clock signal line; and
transition the data signal line from a high state to a low state during the transmission of the clock cycle.

22. The computer readable storage media of claim 19, wherein the instructions operable to transmit the stop bit comprise instructions operable to:
transmit one clock cycle on the clock signal line; and
transition the data signal line from a low state to a high state during the transmission of the clock cycle.

23. The computer readable storage media of claim 19, wherein the instructions operable to transmit the transmit the set of clock cycles comprise instructions operable to:
transmit nine clock cycles on the clock signal line; and
hold the data signal line high during the transmission of the nine clock cycles.

24. The computer readable storage media of claim 18, wherein following at least one initiation of data transfer the instructions are operable to:
receive data from the slave device over the two-wire interface.

25. The computer readable storage media of claim 18, wherein following at least one initiation of data transfer the instructions are operable to:
transmit data to the slave device over the two-wire interface.
